(19) United States
(12) Patent Application Publication
(10) Pub. No.: US 2026/0233897 A1
(43) Pub. Date: Aug. 13, 2026

(54) Liner For Fresh Produce Transportation Bins

(71) Applicant: Hendrik Jacobus SMIT, Paarl (ZA)

(72) Inventor: Hendrik Jacobus SMIT, Paarl (ZA)

(21) Appl. No.: 19/152,839

(22) PCT Filed: May 12, 2023
(86) PCT No.: PCT/ZA2023/050024

§ 371 Date: Jul. 31, 2025

(51) Int. Cl. B65D 25/16; B29D 28/00; B29K 105/04; B65B 55/00; B65D 81/05; B65D 85/34

(52) U.S. Cl. CPC B65D 25/16; B29D 28/00; B65B 55/00; B65D 81/05; B65D 85/345; B29K 2023/06; B29K 2105/04

(57) ABSTRACT

The invention provides a liner for a fresh produce transportation bin, box or crate of various dimensions, which liner includes stabilised expanded polyethylene meshed sheets of which the open area of the mesh ranges from 10% to 50%, in plan view. The invention also relates to a method of protecting fresh produce, method of manufacturing a liner and a system for transporting fresh produce.

### TECHNICAL FIELD OF THE INVENTION

This invention relates to the mitigation of damage to fresh produce during transportation and handling between the harvesting location and a sorting and packing facility. In particular, the invention relates to a liner for fresh produce transportation bins and crates of various dimensions, and a system and method for the protection of fresh produce during bin transportation, handling, and storage.

### BACKGROUND TO THE INVENTION

Fresh produce such as fruit is harvested in the orchards and placed in bins with typical dimensions of 1000 mm by 1200 mm with a height of about 750 mm. The bins are then transported to a packhouse where it is stored until ready for sorting and packing. In the bin, the fruit is in contact with each other, the sides and bottom surfaces of the bin. Due to the weight of the fruit and the vibrations caused by transportation the fruit chafe and bruise during transport and handling. Such bruising and chafing leads to substantial losses to fruit quality, causing downgrading and spoilage which leads to food waste. Studies have shown that of all bruising found on apples up to retail level, most are caused during bin transport and handling already. Between 5% and 10% of all apples are a lost due to bruising. On retail level it was found that on average 61% of apples are bruised and therefore increasing the risk of not being sold for the price it was intended. 31-34% of all fruit inside a bin are in contact with side walls and bottom. Up to 34% of fruit in contact with wooden or plastic side walls and bottom of bin are lost due to bruising, mainly during transportation and handling. In addition, fruit is packed in carton boxes for shipping and transport, and it is also important to avoid damage during such transport and shipping. It is also important for fruit to cool down as fast as possible when it reaches the packhouse to further limit losses.

It is an object of the invention to provide a liner for fresh produce transportation bins or boxes which lowers the chafing and bruising of fruit during transportation and handling while maintaining the necessary ventilation within the bin. It is also an object of the invention to provide a system and method to limit fruit quality losses during transportation in bins to the packhouse and to facilitate efficient cooling when stored in cooled storage facilities.

### GENERAL DESCRIPTION OF THE INVENTION

According to the invention there is provided a liner for fresh produce transportation bins, boxes or crates of various dimensions, which liner includes stabilised expanded polyethylene meshed sheets of which the open area of the mesh range from 10% to 50%, preferably between 15% and 28%, in plan view. The strand thickness or diameter will vary from 4 mm to 10 mm.

It is to be appreciated that the preferred open area of the mesh will depend on the diameter of the produce and product specific post-harvest handling protocol.

The mesh is typically extruded with a circularly arranged outer set of strands at an angle to the axis of the extruder and a circularly arranged inner set of strands at an angle to the axis of the extruder with the outer and inner strands being transverse to each other and adhering to each other at the intersection points. When manufactured by known processes, the expanded polyethylene is resiliently deformable and can be stretched or expanded along its width to open the mesh. It will then return or contract to its extruded closed state. The extruded meshed expanded polyethylene is manufactured by known processes in an expandable tubular sleeve net form with a limited diameter range of about 4-15 cm available to be used to stretch and fit over bottles, fruit, or the like. The extruded meshed expanded polyethylene manufactured in this way is not suitable for use as intended for this invention.

It is to be understood that stabilised expanded mesh means that its expanded dimensions are stable and will not contract back to its closed state. In other words, the stabilised open mesh retains its width or length dimension. In the case of extruded meshed expanded polyethylene, the extruded tubular sleeve may be stretched and allowed to cool in the stretched and stabilised condition. Alternatively, the manufacturing process requires a lateral cut of the extruded tubular sleeve followed by a flattening and finally a stabilisation step by first stretching the mesh to required width dimensions and then to apply heat followed by cooling or a fixing agent to fix the dimensions of the sheet. The extrusion head or tooling is adapted to provide a final width of the liners of about 1200 to 1300 mm, preferably 1250 mm, or part thereof, for fruit bin liners and it is to be appreciated that the current invention requires further manufacturing steps and unique and drastically oversized tooling to reach such widths.

The applicant found that expanded or other resiliently deformable sheets punched to form a mesh or to provide ventilation openings will also function as a liner for a fresh produce transportation bin however, the waste of material during the punching process and high cost of manufacture does not make this liner embodiment feasible in comparison with the embodiments described in the examples. Furthermore, multiple different bin designs with ventilation hole design and positions that vary, also means that a variety of different punched sheet designs had to be manufactured. The industry needs a generic liner that can be cut to fit any existing of future bin design, making it more manageable and sustainable.

The liners may be in the form of rolls of which the width corresponds to the width of the inside of a bin or a box. It is to be appreciated that the sheets may be cut to fit other bruit packing or storing containers such as shipping boxes.

The liners may be in the form of right-angled sheets, dimensioned to line two sides and the bottom of a bin. The liners may be pre-cut according to standard bin sizes or may be cut to a desired length on-site from a roll which is provided with the correct standard bin width. In this case it is to be appreciated that two liners can be used to cover the inner surface of the bin. In another embodiment, the liners may be in the form of general cross, which when fitted inside a bin will cover all the sides and bottom of the bin.

The invention also extends to a system for the protection of fruit transported in a bin, which system includes a liner for a fresh produce transportation bin as described above.

The system may also include elongate bin contents displacement means to provide generally vertical airflow passages into the fresh produce to assist with or facilitate cooling of the fresh produce when stored in the bins in a cooling facility. It is to be appreciated that the large open mesh of the liners also allows free airflow through the sides and bottom of the fresh produce. In one example, the elongate bin contents displacement means may be in the form of an extruded cylinder of expanded polymeric foam with three or more U-shaped or V-shaped channels formed along the length of the displacement means. It is to be appreciated that the U or V-shaped channels provide air flow passages into the fruit when one or more are placed vertically in the bin when the bin is filled. The expanded foam may preferably be resiliently deformable which further assists with limitation of damage due to vibrations during transportation.

The invention also includes a method for the protection of fresh produce during transportation in bins, which method includes the step of lining a fresh produce bin's bottom and/or sides before filling it with fresh produce. The method may also include adding sheets onto the surface of the produce when partially filled and continuing to fill the bin to provide intermediate layers of protection. The method may also include placing elongate bin contents displacement means to provide generally vertical airflow passages into the fresh produce to assist with or facilitate cooling of the fresh produce when stored in the bins in a cooling facility.

The invention also extends to a method of manufacture of the bin liners as described above, which includes the steps of:
extruding tubular sleeve of an expanded polyethylene mesh with a circularly arranged outer set of strands at an angle to the axis of the extruder and a circularly arranged inner set of strands at an angle to the axis of the extruder with the outer and inner strands being transverse to each other and adhering to each other at the intersection points;
stretching the sleeve along its width to a desired width;
cutting the sleeve laterally along its length;
opening the cut sleeve to form a sheet; and
stabilising the sheet in its desired width by allowing it to cool in its stretched state.

### DETAILED DESCRIPTION OF THE INVENTION

The invention is now described by way of example with reference to the accompanying drawings.

In the drawings:

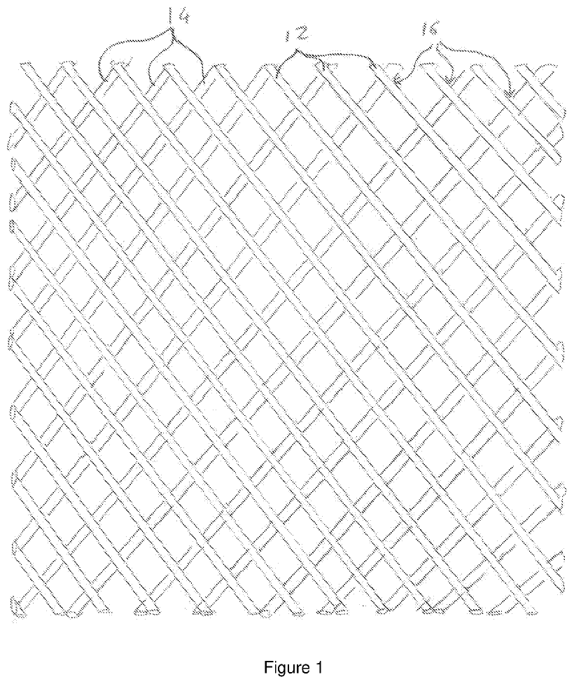

FIG. 1 shows a part of a liner for a fresh produce transportation bin, according to the invention; and

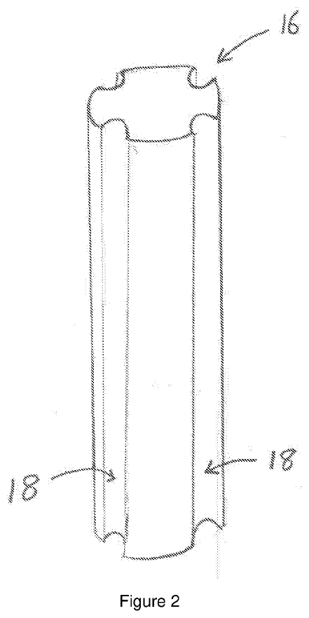

FIG. 2 shows a perspective view of an elongate bin contents displacement means.

Referring now to FIG. 1 the preferred liner for a fresh produce transportation bin is in the form of expanded polyethylene mesh typically extruded with a circularly arranged outer set of strands 12 at an angle to the axis of the extruder and a circularly arranged inner set 14 of strands at an angle to the axis of the extruder with the outer and inner strands being transverse to each other and adhering to each other at the intersection points 16. A sheet is provided by a lateral cut of the extruded tubular sleeve followed by a flattening and finally a stabilisation step by first stretching the mesh to required width dimensions followed by applying heat with a roller fix the dimensions of the sheet. The open area of the mesh range will be 15% to 40% for apples, depending on the diameter of the produce and product specific post-harvest handling protocol. The strand thickness or diameter will vary from 4 mm to 10 mm, where 10 mm will be the cross-over point. The final preferred width of the liner is 1200-1250 mm and is cut to length and/or height of a standard bin's side or floor panels in any possible configuration that will fit the bin.

In one embodiment, the liners are in the form of rolls of which the width corresponds to the width of the inside of a bin. In another embodiment of the invention, the liners are in the form of right-angled sheets, dimensioned to line two sides and the bottom of a bin. The liners are pre-cut according to standard bin sizes or may be cut to a desired length on-site from a roll which is provided with the correct standard bin width. In this case it is to be appreciated that two liners can be used to cover the inner surface of the bin. In another embodiment, the liners are in the form of general cross, which when fitted inside a bin will cover all the sides and bottom of the bin.

As part of a system to protect fresh produce there is provided an elongate bin contents displacement means 16 as shown in FIG. 2 to provide generally vertical airflow passages into the fresh produce to assist with or facilitate cooling of the fresh produce when stored in the bins in a cooling facility. In this example, the elongate bin contents displacement means 16 is in the form of an extruded cylinder of expanded polymeric foam with four U-shaped channels 18 formed along the length of the displacement means.

It shall be understood that the examples are provided for illustrating the invention further and to assist a person skilled in the art with understanding the invention and are not meant to be construed as unduly limiting the reasonable scope of the invention.

1. A liner for a fresh produce transportation bin, box or crate of various dimensions, which liner comprises stabilised expanded polyethylene meshed sheets of which the open area of the mesh ranges from 10% to 50%, in plan view, which mesh sheet is extruded in tubular form comprising circularly arranged outer set of strands at an angle to the axis of the extruder and a circularly arranged inner set of strands at an angle to the axis of the extruder with the outer and inner strands being transverse to each other and adhering to each other at the intersection points.

2. A liner as claimed in claim 1, wherein the open area is in the range of between 15% and 28%.

3. A liner as claimed in claim 1, wherein strands of the mesh have a thickness varying from 4 mm to 10 mm.

4. A liner as claimed in claim 1, wherein an extrusion head is adapted to provide a final width of the liners of between 1200 and 1300 mm.

5. A liner as claimed in claim 4, wherein the liners are rolled in the form of rolls of which the width corresponds to the width of the inside of a bin, crate or a box.

6. A liner as claimed in claim 4, wherein the liners are cut to the form of right-angled sheets, dimensioned to line two sides and the bottom of a bin.

7. A liner as claimed in claim 4, wherein the liners are cut to the form of a general cross, which when fitted inside a bin will cover all the sides and bottom of a bin.

8. A system for the protection of fruit transported in a bin, which system comprises a liner for a fresh produce transportation bin as claimed in claim 1.

9. A system as claimed in claim 8, which comprises an elongate bin contents displacement means to provide generally vertical airflow passages into the fresh produce to assist with or facilitate cooling of the fresh produce when stored in the bins in a cooling facility.

10. A system as claimed in claim 9, wherein the elongate bin contents displacement means are in the form of an extruded cylinder of expanded resiliently deformable polymeric foam with three or more U-shaped or V-shaped channels formed along the length of the displacement means.

11. A method for the protection of fresh produce during transportation in bins, which method comprises the step of lining a fresh produce bin's bottom and/or sides with a liner as claimed in claim 1 before filling it with fresh produce.

12. A method as claimed in claim 11, which comprises the step of adding sheets onto the surface of the produce when partially filled and continuing to fill the bin to provide intermediate layers of protection.

13. A method as claimed in claim 11, which comprises the step of placing elongate bin contents displacement means to provide generally vertical airflow passages into the fresh produce to assist with or facilitate cooling of the fresh produce when stored in the bins in a cooling facility.

14. A method of manufacture of a bin liner, which comprises the steps of:
extruding tubular sleeve of an expanded polyethylene mesh with a circularly arranged outer set of strands at an angle to the axis of the extruder and a circularly arranged inner set of strands at an angle to the axis of the extruder with the outer and inner strands being transverse to each other and adhering to each other at the intersection points;
stretching the sleeve along its width to a desired width;
cutting the sleeve laterally along its length;
opening the cut sleeve to form a sheet; and
stabilising the sheet in its desired width by allowing it to cool in its stretched state.
